(19) United States
(12) Patent Application Publication
(10) Pub. No.: US 2013/0156311 A1
(43) Pub. Date: Jun. 20, 2013

(54) METHOD AND APPARATUS FOR PROCESSING IMAGE SIGNAL

(71) Applicants: Seo Young CHOI, Seoul (KR); Kwan Jung OH, Hwaseong Si (KR); Ho Cheon WEY, Seongnam-si (KR); Du Sik PARK, Suwon-si (KR); Ho Young LEE, Suwon-si (KR)

(72) Inventors: Seo Young CHOI, Seoul (KR); Kwan Jung OH, Hwaseong Si (KR); Ho Cheon WEY, Seongnam-si (KR); Du Sik PARK, Suwon-si (KR); Ho Young LEE, Suwon-si (KR)

(73) Assignee: SAMSUNG ELECTRONICS CO., LTD., Suwon-si (KR)

(21) Appl. No.: 13/448,663

(22) Filed: Apr. 17, 2012

(30) Foreign Application Priority Data
Dec. 16, 2011 (KR) 10-2011-0136218

(51) Int. Cl. G06K 9/36

(52) U.S. Cl. 382/166

(57) ABSTRACT

A method and apparatus for processing an image signal includes an image signal encoding apparatus and an image signal decoding apparatus that use an independent luminance and chrominance image signal to reduce a crosstalk. The independent luminance and chrominance image signal may include a luminance signal and a chrominance signal. The image signal encoding apparatus and the image decoding apparatus may perform down-sampling or up-sampling on the chrominance signal. The image signal encoding apparatus and the image decoding apparatus may increase a compression efficiency of the independent luminance and chrominance image signal, by applying different quantization parameters and different bit-depths to the luminance signal and the chrominance signal, respectively.

### CROSS-REFERENCE TO RELATED APPLICATIONS

This application claims the priority benefit of Korean Patent Application No. 10-2011-0136218, filed on Dec. 16, 2011, in the Korean Intellectual Property Office, the disclosure of which is incorporated herein by reference.

### BACKGROUND

1. Field

The following description relates to a method and apparatus for processing an image signal, and more particularly, to a method and apparatus for encoding and decoding an image signal using an independent luminance and chrominance image signal.

2. Description of the Related Art

A luminance and chrominance image signal is widely used for generation, storage, and transmission of image contents. The luminance and chrominance image signal may include a luminance signal or a luminance image signal, and a chrominance signal or a chrominance image signal. The luminance signal indicates a brightness of an achromatic component. The chrominance signal indicates a relative amount of a yellow-blue chromatic component and a relative amount of a red-green chromatic component.

A luminance and chrominance image signal defined by conventional standards such as ITU-R BT.709 may cause a crosstalk problem. Crosstalk refers to a case in which a luminance signal includes information about chrominance, and a chrominance signal includes information about luminance.

When a resulting image signal is generated by compressing an image signal of an original image, the crosstalk may cause deterioration in a quality of the resulting image signal. Accordingly, an image signal in which a crosstalk is reduced should be used in an image compression process.

### SUMMARY

The foregoing and/or other aspects are achieved by providing an apparatus for processing an image signal, the apparatus including an independent luminance and chrominance signal generating unit to convert a linear red, green, and blue (RGB) signal to an independent luminance and chrominance image signal including a luminance signal and a chrominance signal, and an image signal encoding unit to encode the independent luminance and chrominance image signal. Here, a non-linearization may be performed on each of the luminance signal and the chrominance signal, and the non-linearization may reduce a crosstalk property of the independent luminance and chrominance image signal.

The chrominance signal of the independent luminance and chrominance image signal may have a value of 0 with respect to an achromatic color.

The apparatus may further include a bit-depth converting unit to select at least one of the luminance signal and the chrominance signal of the independent luminance and chrominance image signal, and to convert a bit-depth of the at least one signal selected.

The apparatus may further include a chrominance signal down-sampling unit to perform down-sampling on the chrominance signal of the independent luminance and chrominance image signal.

The image signal encoding unit may include a quantization determining unit to determine different quantization parameter indices with respect to the luminance signal and the chrominance signal of the independent luminance and chrominance image signal, respectively.

The apparatus may further include a luminance and chrominance image signal converting unit to convert an input image signal including a luminance signal and a chrominance signal to the linear RGB signal.

The luminance and chrominance image signal converting unit may include a hue information detecting unit to detect a red chromatic component, a magenta chromatic component, and a purple chromatic component from the chrominance signal of the input image signal, and a hue information comparing unit to compare whether each of the detected red chromatic component, the detected magenta chromatic component, and the detected purple chromatic component has a value greater than a threshold value.

The luminance and chrominance image signal converting unit may determine whether to generate the independent luminance and chrominance image signal depending on a result of the comparison.

The independent luminance and chrominance image signal generating unit may include a linear luminance signal generating unit to generate a linear luminance signal based on the linear RGB signal, a non-linear luminance signal generating unit to convert the linear luminance signal to a non-linear luminance signal, an RGB signal converting unit to convert the linear RGB signal to a non-linear R′G′B′ signal, and a chrominance signal generating unit to generate the chrominance signal of the independent luminance and chrominance image signal, using the non-linear luminance signal and the non-linear R′G′B′ signal.

The non-linear luminance signal may correspond to the luminance signal of the independent luminance and chrominance image signal.

The foregoing and/or other aspects are achieved by providing a method of processing an image signal, the method including converting a linear RGB signal to an independent luminance and chrominance image signal including a luminance signal and a chrominance signal, and encoding the independent luminance and chrominance image signal. Here, a non-linearization may be performed on each of the luminance signal and the chrominance signal, and the non-linearization may reduce a crosstalk property of the independent luminance and chrominance image signal.

The foregoing and/or other aspects are achieved by providing an apparatus for processing an image signal, the apparatus including an image signal decoding unit to generate a decoded image signal by decoding an encoded image signal, and a resulting image signal generating unit to generate a resulting image signal by restoring the decoded image signal to an RGB signal. Here, the decoded image signal may correspond to a luminance and chrominance image signal. The resulting image signal generating unit may include a non-linear image signal generating unit to convert the luminance and chrominance image signal to a non-linear R′G′B′ signal, a linear image signal generating unit to convert the non-linear R′G′B′ signal to a linear RGB signal including a linear luminance signal, a linear RB signal, and a linear GB signal, and an RGB signal completing unit to obtain a full set of the RGB signal, by calculating a linear G signal or a linear R signal of the linear RGB signal based on the linear luminance signal, the linear RB signal, and the linear GB signal of the linear RGB signal.

The non-linear image signal generating unit may convert the luminance and chrominance image signal to a non-linear X′Y′Z′ signal.

The linear image signal generating unit may convert the non-linear X′Y′Z′ signal to a linear XYZ signal.

The resulting image signal generating unit may further include an XYZ signal converting unit to convert the linear XYZ signal to the RGB signal.

The resulting image signal generating unit may generate a resulting image using the RGB signal.

The decoded image signal may include a chrominance signal.

The apparatus may include a chrominance signal up-sampling unit to up-sample values in a chrominance signal corresponding to a plurality of pixels represented by the decoded image signal, to values corresponding to the plurality of pixels, respectively.

The decoded image signal may include a luminance signal and a chrominance signal.

The apparatus may include a bit-depth converting unit to convert bit-depths of at least one of a luminance signal and a chrominance signal of the decoded image signal.

The foregoing and/or other aspects are achieved by providing a method of processing an image signal, the method including generating a decoded image signal by decoding an encoded image signal, and generating a resulting image signal by restoring the decoded image signal to an RGB signal. Here, the decoded image signal may correspond to a luminance and chrominance image signal. The generating of the resulting image signal may include converting the luminance and chrominance image signal to a non-linear R′G′B′ signal, converting the non-linear R′G′B′ signal to a linear RGB signal including a linear luminance signal, a linear RB signal, and a linear GB signal, and obtaining a full set of the RGB signal, by calculating a linear G signal or a linear R signal of the linear RGB signal based on the linear luminance signal, the linear RB signal, and the linear GB signal of the linear RGB signal.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an apparatus for processing an image signal according to example embodiments;

FIG. 2 illustrates a method of processing an image signal according to example embodiments;

FIG. 3 illustrates a method of generating an independent luminance and chrominance image signal according to example embodiments;

FIG. 4 illustrates a method of converting a luminance and chrominance image signal according to example embodiments;

FIG. 5 illustrates an apparatus for processing an image signal according to other example embodiments;

FIG. 6 illustrates a method of processing an image signal according to other example embodiments; and

FIG. 7 illustrates a method of generating an image signal according to example embodiments.

### DETAILED DESCRIPTION

Reference will now be made in detail to embodiments, examples of which are illustrated in the accompanying drawings, wherein like reference numerals refer to like elements throughout. Embodiments are described below to explain the present disclosure by referring to the figures.

Hereinafter, conventional standards may refer to standards associated with image processing, such as ITU-R BT.709, for example. A luminance and chrominance image signal of the conventional standards may refer to a luminance and chrominance image signal Y′C_{b}′Cᵣ′ that may be defined by the conventional standards.

RGB is an acronym for red, green, and blue.

Crosstalk between a luminance signal and a chrominance signal defined by the conventional standards may be generated mainly as a result of generating a luminance signal. A physical unit indicating brightness information is luminance, expressed as candelas per square meter (cd/m²). Generally, there exists a linearly proportional relationship between a value of a linear RGB signal constituting an image and a luminance of the linear RGB signal. However, a luminance signal defined by the conventional standards is generated by using a non-linear R′G′B′ signal, instead of the linear RGB signal having a proportional relationship with a luminance signal. Accordingly, the luminance signal may include chrominance information, and the chrominance signal may include luminance information.

A problem caused by the crosstalk is definitely observed after subsampling with respect to chrominance components, or subsampling and compression with respect to the chrominance components is applied to an image composed mainly of a red chromatic component, a magenta chromatic component, and a purple chromatic component. The foregoing phenomenon occurs because crosstalk is brought about when a chromatic component, different from the red chromatic component, the magenta chromatic component, and the purple chromatic component, is mixed in the subsampling process. Accordingly, when the image composed mainly of the red chromatic component, the magenta chromatic component, and the purple chromatic component is converted to a luminance and chrominance image signal by the conventional standards, and subsampling and compression are applied to chrominance components, a deterioration in quality may be observed in a resulting image generated by the application, compared to an image composed mainly of other chromatic components.

A human eye has a higher visual sensitivity to a change in brightness of an achromatic component, when compared to a change in yellow-blue chromatic component or red-green chromatic component. In view of such a property in the visual sensitivity of a human, a chrominance signal representing chroma information and hue information using relative amounts of a yellow-blue chromatic component and a red-green chromatic component may be subsampled during compression of an image signal, and a luminance signal representing brightness information may be preserved during the compression of the image signal.

In certain image compression standards, a chrominance signal in which four pixels are processed using a downsize filter of a 4:2:2 format or a 4:2:0 format is used. The amount of information of a chrominance image may be reduced by a ratio of ½ or ¼, by the process. Also, other image compression standards propose a chrominance signal that is processed by a downsize filter of a 4:4:4 format used for a high-quality environment, and a downsize filter of a 4:1:0 format used for a low quality environment.

Generally, in image compression standards, defining an encoding operation of a luminance and chrominance image signal, an identical quantization parameter and an identical bit-depth are applied to both a luminance signal and a chrominance signal. However, when a new independent luminance and chrominance image signal in which a crosstalk property is reduced is encoded, an improvement in compression efficiency of the encoding may be expected by applying different quantization parameters and bit-depths to the luminance signal and the chrominance signal.

In the following embodiments, a method of generating the independent luminance and chrominance image signal in which the crosstalk property is reduced, and a method of applying different quantization or different bit-depths to the luminance signal and the chrominance signal will be described.

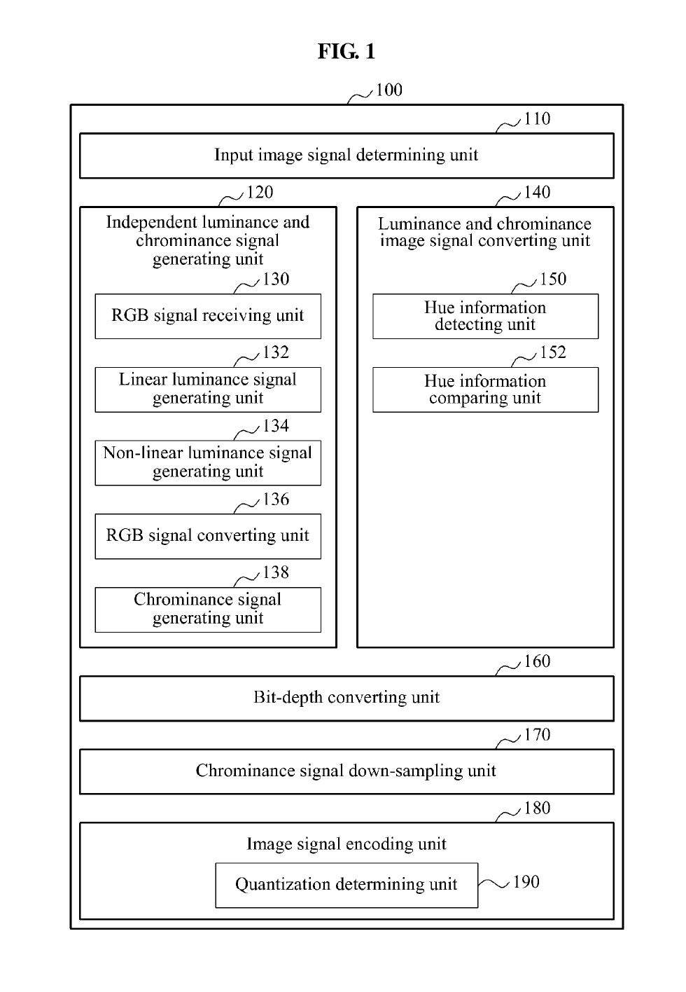

FIG. 1 illustrates an apparatus 100 for processing an image signal according to example embodiments.

The apparatus 100 may include an input image signal determining unit 110, an independent luminance and chrominance image signal generating unit 120, a luminance and chrominance image signal converting unit 140, a bit-depth converting unit 160, a chrominance signal down-sampling unit 170, and an image signal encoding unit 180.

The independent luminance and chrominance image signal generating unit 120 may include an RGB signal receiving unit 130, a linear luminance signal generating unit 132, a non-linear luminance signal generating unit 134, an RGB signal converting unit 136, and a chrominance signal generating unit 138.

The luminance and chrominance image signal converting unit 140 may include a hue information detecting unit 150, and a hue information comparing unit 152.

The image signal encoding unit 180 may include a quantization determining unit 190.

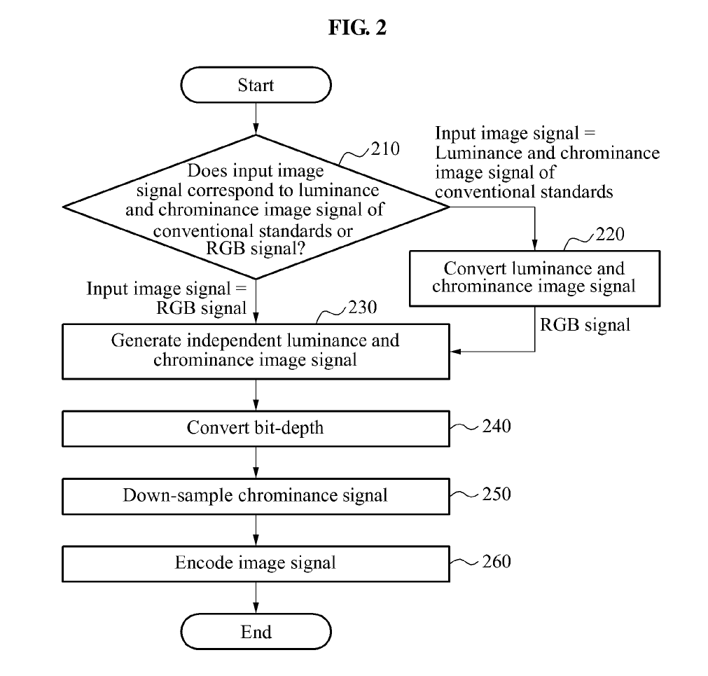

The aforementioned elements 110, 120, 130, 132, 134, 136, 138, 140, 150, 152, 160, 170, 180, and 190 will be described in detail with reference to FIGS. 2 through 4.

FIG. 2 illustrates a method of processing an image signal according to example embodiments.

An input image signal may correspond to 1) a luminance and chrominance image signal of conventional standards, or 2) an RGB signal or a linear RGB signal.

In operation 210, the input image signal determining unit 110 may determine whether the input image signal corresponds to the luminance and chrominance image signal of the conventional standards, or the RGB signal.

When the input image signal corresponds to the luminance and chrominance image signal of the conventional standards, the input image signal determining unit 110 may transmit the input image signal to the luminance and chrominance image signal converting unit 140. When the input image signal corresponds to the RGB signal, the input image signal determining unit 110 may transmit the input image signal to the independent luminance and chrominance image signal generating unit 120.

In operation 220, the luminance and chrominance image signal converting unit 140 may convert the input image signal including a luminance signal and a chrominance signal to an RGB signal.

The input image signal that is input to the luminance and chrominance image signal converting unit 140 may correspond to a luminance and chrominance image signal Y′C_{b}′Cᵣ′ of the conventional standards.

The luminance and chrominance image signal converting unit 140 may convert the luminance and chrominance image signal Y′C_{b}′Cᵣ′ of the conventional standards to a non-linear R′G′B′ signal, by applying a matrix of Equation 1 to the luminance and chrominance image signal Y′C_{b}′Cᵣ′ of the conventional standards. Here, applying a matrix to a predetermined signal may refer to multiplying the matrix and components of the predetermined signal.

$$[ \begin{matrix}{R}^{′} \\ {G}^{′} \\ {B}^{′}\end{matrix} ] = [ \begin{matrix}1 & - 0.0002 & 1.5748 \\ 1 & - 0.1873 & - 0.4681 \\ 1 & 1.8556 & 0.0001\end{matrix} ] [ \begin{matrix}{Y}^{′} \\ {C}_{b}^{′} \\ {C}_{r}^{′}\end{matrix} ] \qquad [ Equation 1 ]$$

The luminance and chrominance image signal converting unit 140 may convert the non-linear R′G′B′ signal to a linear RGB signal, by applying a linearization function of Equation 2 to the non-linear R′G′B′ signal. Here, applying a function to a predetermined signal may refer to using the predetermined signal or components of the predetermined signal as an input value or input values of the function.

$$S \{ \begin{matrix}{S}^{′} / 4.5 , & 0 \leq S \leq 0.0814 \\ {[ ( {S}^{′} + 0.0993 ) / 1.0993 ]}^{( 1 / 0.45 )} , & 0.0814 〈 S \leq 1\end{matrix} \qquad [ Equation 2 ]$$

In Equation 2 above, S′ denotes the non-linear R′G′B′ signal and S denotes the linear RGB signal.

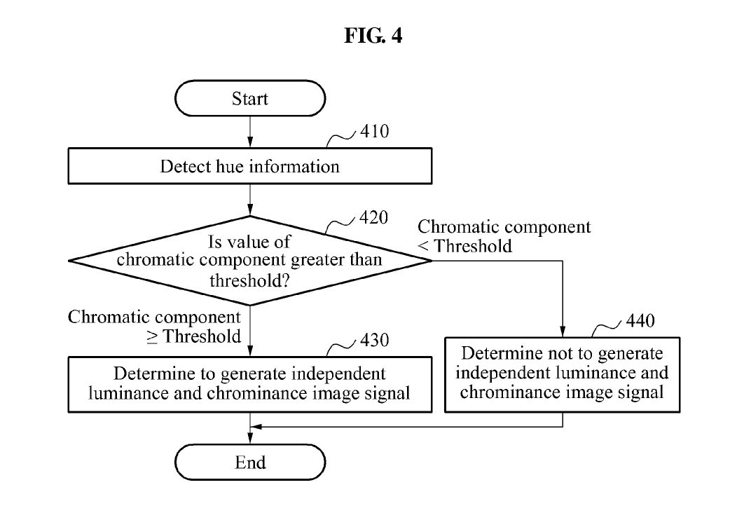

A configuration and additional functions of the luminance and chrominance image signal converting unit 140 will be further described with reference to FIG. 4.

In operation 230, the independent luminance and chrominance image signal generating unit 120 may convert the linear RGB signal to an independent luminance and chrominance image signal. The independent luminance and chrominance image signal may include a luminance signal and a chrominance signal.

The linear RGB signal may correspond to 1) the aforementioned input image signal or 2) the linear RGB signal generated by the luminance and chrominance image signal converting unit 140. The independent luminance and chrominance image signal may correspond to a signal in which a crosstalk property is reduced, when compared to the luminance and chrominance image signal of the conventional standards. That is, a non-linearization may be performed on the luminance signal and the chrominance signal to reduce the crosstalk property of the independent luminance and chrominance image signal.

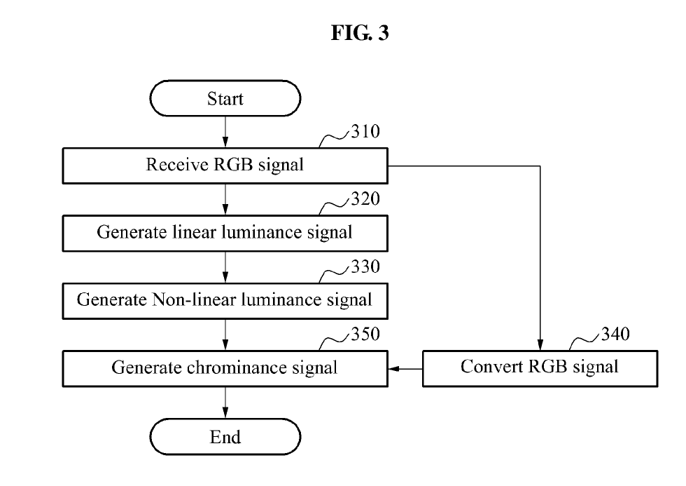

A configuration and additional functions of the independent luminance and chrominance image signal generating unit 120 will be further described with reference to FIG. 3.

In operation 240, the bit-depth converting unit 160 may determine optimal bit-depths with respect to each of the luminance signal and the chrominance signal of the independent luminance and chrominance image signal, based on a property of the independent luminance and chrominance image signal. The bit-depth converting unit 160 may select at least one of the luminance signal and the chrominance signal of the independent luminance and chrominance image signal based on the determined optimal bit-depths, and may convert a bit-depth of each of the at least one signal selected.

For example, the bit-depth converting unit 160 may increase or maintain the bit-depth of the luminance signal, and may reduce or maintain the bit-depth of the chrominance signal. The bit-depth converting unit 160 may reduce the bit-depth of the chrominance signal, thereby improving a compression efficiency of image signal encoding.

In operation 250, the chrominance signal down-sampling unit 170 may perform down-sampling on the chrominance signal of the independent luminance and chrominance image signal.

The chrominance signal down-sampling unit 170 may down-sample a plurality of values in the chrominance signal corresponding to a plurality of pixels represented by the independent luminance and chrominance image signal to a value corresponding to the entire plurality of pixels. For example, the value corresponding to all of the plurality of pixels may correspond to an average of a plurality of values. Here, the plurality of pixels may correspond to pixels constituting a block in a frame.

Operations 240 and 250 may be omitted, or may be performed in reverse order.

In operation 260, the image signal encoding unit 180 may generate an encoded independent luminance and chrominance image signal by encoding the independent luminance and chrominance image signal. The image signal encoding unit 180 may reduce an amount of information of the independent luminance and chrominance image signal, by encoding the independent luminance and chrominance image signal using an image compression algorithm.

In operation 260, different quantization parameter values such as quantization parameter indices (QPIs), for example, may be applied, by the quantization determining unit 190, to the luminance signal and the chrominance signal of the independent luminance and chrominance image signal. The quantization determining unit 190 may determine different quantization parameter indices with respect to each of the luminance signal and the chrominance signal in the independent luminance and chrominance image signal.

The image signal encoding unit 180 may enable a quantization with respect to the chrominance signal to be greater than a quantization with respect to the luminance signal, using the determined quantization parameter indices.

By performing operations 210 through 260, the input image signal may be converted to the independent luminance and chrominance image signal in which the crosstalk property is reduced, when compared to the luminance and chrominance image signal of the conventional standards. The luminance signal and the chrominance signal of the independent luminance and chrominance image signal generated through the conversion may be quantized using different bit-depths. After the quantization, the independent luminance and chrominance image signal may be encoded.

Luminance information and chrominance information may be separated more precisely from the independent luminance and chrominance signal, when compared to the luminance and chrominance image signal of the conventional standards.

When the independent luminance and chrominance image signal is used, various schemes may be applied to encoding and decoding processes, or pre-processing and post-processing of the encoding and decoding processes, for improvement in compression efficiency of the image signal and effective preservation of color information of an original image. For example, an image having a quality similar to a quality of an image generated using the luminance signal and the chrominance signal of the conventional standards may be provided using a chrominance signal having a lesser amount of information. A quality provided, in a 4:1:0 format, by the independent luminance and chrominance image signal may be similar to a quality provided, in a 4:2:0 format, by the luminance and chrominance image signal of the conventional standards. Also, a greater range of error may be allowed to the chrominance signal by the independent luminance and chrominance image signal. Accordingly, the application may increase a compression rate with respect to the independent luminance and chrominance image signal. For example, the compression rate may be improved by making the quantization with respect to the chrominance signal of the independent luminance and chrominance image signal be greater. Also, the compression rate of the independent luminance and chrominance image signal may be improved by applying different bit-depths to each of the luminance signal and the chrominance signal. For example, a 10-bit depth may be applied to each of the luminance signal and the chrominance signal of the luminance and chrominance image signal of the conventional standards. A 12-bit depth may be applied to the luminance signal of the independent luminance and chrominance image signal, and an 8-bit depth may be applied to the chrominance signal of the independent luminance and chrominance image signal.

FIG. 3 illustrates a method of generating an independent luminance and chrominance image signal according to example embodiments.

The independent luminance and chrominance image signal generating unit 120 may generate an independent luminance and chrominance image signal using a linear RGB signal, by performing operations 310 through 350.

Operation 310 may be performed after operation 210 or 220 of FIG. 2.

In operation 310, the RGB signal receiving unit 130 may receive a linear RGB signal. In this instance, the linear RGB signal may correspond to an input image transmitted from the input image signal determining unit 110, or a linear RGB signal transmitted from the luminance and chrominance image signal converting unit 140.

The RGB signal receiving unit 130 may transmit the received linear RGB signal to the linear luminance signal generating unit 132 and the RGB signal converting unit 136.

In operation 320, the linear luminance signal generating unit 132 may generate a linear luminance signal, that is, a signal Y, based on the linear RGB signal, and may output the generated signal Y. Here, the signal Y may correspond to a weighted sum of a component R or a signal R, a component G or a signal G, and a component B or a signal B of the linear RGB signal, as expressed by Equation 3.

Y=0.2126·R+0.7152·G+0.0722·B [Equation 3]

In operation 330, the non-linear luminance signal generating unit 134 may convert the signal Y to a non-linear luminance signal, that is, a signal Y′, by applying a non-linearization function of Equation 4 to the signal Y, and may output the signal Y′. Here, the non-linearization function may correspond to a linear to non-linear signal conversion function. The signal Y′ may correspond to a luminance signal of the independent luminance and chrominance image signal.

$${S}^{′} \{ \begin{matrix}4.5 \cdot S , & 0 \leq S \leq 0.0181 \\ 1.0993 \cdot {S}^{0.45} - 0.0993 , & 0.0181 〈 S \leq 1\end{matrix} \qquad [ Equation 4 ]$$

In Equation 4 above, S denotes a linear luminance signal, a linear RGB signal, or a linear XYZ signal and S′ denotes a non-linear luminance signal, a non-linear R′G′B′ signal, or a non-linear X′Y′Z′ signal.

In operation 340, the RGB signal converting unit 136 may convert the linear RGB signal to a non-linear R′G′B′ signal by applying the non-linearization function of Equation 4 to the linear RGB signal, and may output the non-linear R′G′B′ signal.

Also, the RGB signal converting unit 136 may convert the linear RGB signal to a linear XYZ signal by applying a matrix of Equation 5 to the linear RGB signal.

$$[ \begin{matrix}X \\ Y \\ Z\end{matrix} ] [ \begin{matrix}0.4124 & 0.3576 & 0.1805 \\ 0.2126 & 0.7152 & 0.0722 \\ 0.0193 & 0.1192 & 0.9505\end{matrix} ] [ \begin{matrix}R \\ G \\ B\end{matrix} ] \qquad [ Equation 5 ]$$

The RGB signal converting unit 136 may convert the linear XYZ signal to a non-linear X′Y′Z′ signal by applying the non-linearization function of Equation 4 to the linear XYZ signal. The RGB signal converting unit 136 may output the non-linear X′Y′Z′ signal generated by the conversion.

In operation 350, the chrominance signal generating unit 138 may generate and output a chrominance signal using the signal Y′ output from the non-linear luminance signal generating unit 134, and the non-linear R′G′B′ signal or the non-linear X′Y′Z′ signal output from the RGB signal converting unit 136. The chrominance signal may include chroma information and hue information.

As expressed by Equation 6, the chrominance signal generating unit 138 may generate chrominance signals, that is, a signal C′_{yb} and a signal C′_{rg}, based on the signal Y′, a signal R′, and a signal B′. The chrominance signals may correspond to chrominance signals of the independent luminance and chrominance image signal. The chrominance signal generating unit 138 may generate the signal C′_{yb}, by applying an upper function of Equation 6 to the signal B′ and the signal Y′. The chrominance signal generating unit 138 may generate the signal C′_{rg}, by applying a lower function of Equation 6 to the signal R′ and the signal Y′.

$${C}_{yb}^{′} = \{ \begin{matrix}\frac{{B}^{′} - {Y}^{′}}{1.9272} , & - 0.9636 \leq {B}^{′} - {Y}^{′} \leq 0 \\ \frac{{B}^{′} - {Y}^{′}}{1.5244} , & 0 < {B}^{′} - {Y}^{′} \leq 0.7622\end{matrix} \\ {C}_{rg}^{′} = \{ \begin{matrix}\frac{{R}^{′} - {Y}^{′}}{1.7758} , & - 0.8879 \leq {R}^{′} - {Y}^{′} \leq 0 \\ \frac{{R}^{′} - {Y}^{′}}{1.1030} , & 0 < {R}^{′} - {Y}^{′} \leq 0.5515\end{matrix} \qquad [ Equation 6 ]$$

As expressed by Equation 7, the chrominance signal generating unit 138 may generate a signal C′_{yb} and a signal C′_{rg}, based on the signal Y′, the signal B′, and the signal G′. The chrominance signal generating unit 138 may generate the signal C′_{yb}, by applying an upper function of Equation 7 to the signal B′ and the signal Y′. The chrominance signal generating unit 138 may generate the signal C′_{rg}, by applying a lower function of Equation 7 to the signal G′ and the signal Y′.

$${C}_{yb}^{′} = \{ \begin{matrix}\frac{{B}^{′} - {Y}^{′}}{1.9272} , & - 0.9636 \leq {B}^{′} - {Y}^{′} \leq 0 \\ \frac{{B}^{′} - {Y}^{′}}{1.5244} , & 0 < {B}^{′} - {Y}^{′} \leq 0.7622\end{matrix} \\ {C}_{rg}^{′} = \{ \begin{matrix}\frac{{G}^{′} - {Y}^{′}}{1.0510} , & - 0.5255 \leq {G}^{′} - {Y}^{′} \leq 0 \\ \frac{{G}^{′} - {Y}^{′}}{0.3078} , & 0 < {G}^{′} - {Y}^{′} \leq 0.1539\end{matrix} \qquad [ Equation 7 ]$$

As expressed by Equation 8, the chrominance signal generating unit 138 may generate a signal C′_{yb} and a signal C′_{rg}, based on the signal Y′, a signal X′, and a signal Z′. The chrominance signal generating unit 138 may generate a signal yb′ by applying a first function of Equation 8 to the signal X′, the signal Y′, and the signal Z′, and may generate a signal rg′ by applying a second function of Equation 8 to the signal X′, the signal Y′, and the signal Z′. Each of the signal yb′ and the signal rg′ may correspond to a weighted sum of the signal Y′, the signal X′, and the signal Z′. The chrominance signal generating unit 138 may generate the signal C′_{yb}, by applying a third function of Equation 8 to the signal yb′. The chrominance signal generating unit 138 may generate the signal C′_{rg}, by applying a fourth function of Equation 8 to the signal rg′.

$${yb}^{′} = - 0.325 \cdot {X}^{′} - 0.325 \cdot {Y}^{′} + 0.65 \cdot {Z}^{′} \\ {rg}^{′} = 0.6476 \cdot {X}^{′} - 0.6472 \cdot {Y}^{′} - 0.0004 \cdot {Z}^{′} \\ {C}_{yb}^{′} = \{ \begin{matrix}\frac{{yb}^{′}}{0.7756} , & - 0.3878 \leq {yb}^{′} \leq 0 \\ \frac{{yb}^{′}}{0.7866} , & 0 < {yb}^{′} \leq 0.3933\end{matrix} \\ {C}_{rg}^{′} = \{ \begin{matrix}\frac{{rg}^{′}}{0.3070} , & - 0.1535 \leq {rg}^{′} \leq 0 \\ \frac{{rg}^{′}}{0.3418} , & 0 < {rg}^{′} \leq 0.1709\end{matrix} \qquad [ Equation 8 ]$$

The chrominance signals generated by each of Equations 6 through 8, that is, the signal C′_{yb} and the signal C′_{rg}, may have a value of “0” with respect to an achromatic color. That is, when a color of a predetermined pixel corresponds to an achromatic color, a value of a chrominance signal with respect to the predetermined pixel may correspond to “0.”

By performing operations 310 through 350, the RGB signal may be converted to the independent luminance and chrominance image signal in which the crosstalk property is reduced, when compared to the luminance and chrominance image signal of the conventional standards.

FIG. 4 illustrates a method of converting a luminance and chrominance image signal according to example embodiments.

Operation 220 may include operations 410 through 440.

The luminance and chrominance image signal converting unit 140 may determine whether to convert a luminance and chrominance image signal of conventional standards to a non-linear R′G′B′ signal, by performing operations 410 through 440.

An input image signal that may be input into the luminance and chrominance image signal converting unit 140 may correspond to the luminance and chrominance image signal of the conventional standards.

In operations 410 and 420, the luminance and chrominance image signal converting unit 140 may analyze a color property of the input image signal. Also, in operations 420, 430, and 440, depending on a result of the analysis, the luminance and chrominance image signal converting unit 140 may determine whether to use the input image signal or an independent luminance and chrominance image signal for a bit-depth conversion, chrominance signal down-sampling, or image signal encoding.

A crosstalk property of the luminance and chrominance image signal of the conventional standards may not be common in all types of images. Crosstalk may be generated at a greater size in an image including a great amount of a red chromatic component, a magenta chromatic component, and a purple chromatic component. Accordingly, whether to convert the luminance and chrominance image signal to an RGB signal may be determined based on threshold values with respect to the chromatic components.

In operation 410, the hue information detecting unit 150 may detect a red chromatic component, a magenta chromatic component, and a purple chromatic component from chrominance signals C_{b}′ and Cᵣ′ in an input image signal.

The hue information detecting unit 150 may convert a luminance signal and a chrominance signal in the input image signal to signals in another color space. The hue information detecting unit 150 may detect a red chromatic component, a magenta chromatic component, and a purple chromatic component from the signals in the other color space.

In operation 420, the hue information comparing unit 152 may compare whether each of the detected red chromatic component, the detected magenta chromatic component, and the detected purple chromatic component has a value greater than a threshold value. Subsequently, depending on a result of the comparison, one of operations 430 and 440 may be performed. For example, when at least one of the red chromatic component, the magenta chromatic component, and the purple chromatic component has a value greater than or equal to the threshold value, operation 430 may be performed. Conversely, when all of the red chromatic component, the magenta chromatic component, and the purple chromatic component have values less than the threshold value, operation 440 may be performed.

In operation 430, the luminance and chrominance image signal converting unit 140 may determine whether to generate the independent luminance and chrominance image signal, depending on a result of the comparison.

When the input image signal includes at least one of the red chromatic component, the magenta chromatic component, and the purple chromatic component that is greater than or equal to the threshold value, the independent luminance and chrominance image signal generating unit 120 may generate the independent luminance and chrominance image signal in which a crosstalk property is reduced, when compared to the luminance and chrominance image signal of the conventional standards. When the independent luminance and chrominance image signal with the reduced crosstalk property is used in image signal encoding, a compression efficiency of the image signal encoding may be improved, and a quality of a compressed image may be improved.

The luminance and chrominance image signal converting unit 140 may convert, to an RGB signal, the input image signal including the luminance signal and the chrominance signal, in order to generate the independent luminance and chrominance image signal. The luminance and chrominance image signal converting unit 140 may transmit the RGB signal to the independent luminance and chrominance image signal generating unit 120.

In operation 440, the luminance and chrominance image signal converting unit 140 may determine not to generate the independent luminance and chrominance image signal. In this instance, in embodiments described with reference to FIG. 2, the input image signal may be used instead of the independent luminance and chrominance image signal.

That is, when all of the red chromatic component, the magenta chromatic component, and the purple chromatic component in the luminance and chrominance image signal of the conventional standards have values less than the threshold value, a great deal of crosstalk may not arise. Accordingly, the input image signal may be used for encoding the image signal, instead of the independent luminance and chrominance image signal.

For example, when the luminance and chrominance image signal converting unit 140 determines not to generate the independent luminance and chrominance image signal, the independent luminance and chrominance image signal generating unit 120 may not be operated, and the input image signal may be transmitted to the bit-depth converting unit 160, the chrominance signal down-sampling unit 170, or the image signal encoding unit 180, instead of the independent luminance and chrominance image signal. Here, the image signal encoding unit 180 may encode the luminance and chrominance image signal by the conventional standards. For example, the image signal encoding unit 180 may encode the luminance and chrominance image signal of the conventional standards using an image compression algorithm, thereby reducing an amount of information of the luminance and chrominance image signal of the conventional standards.

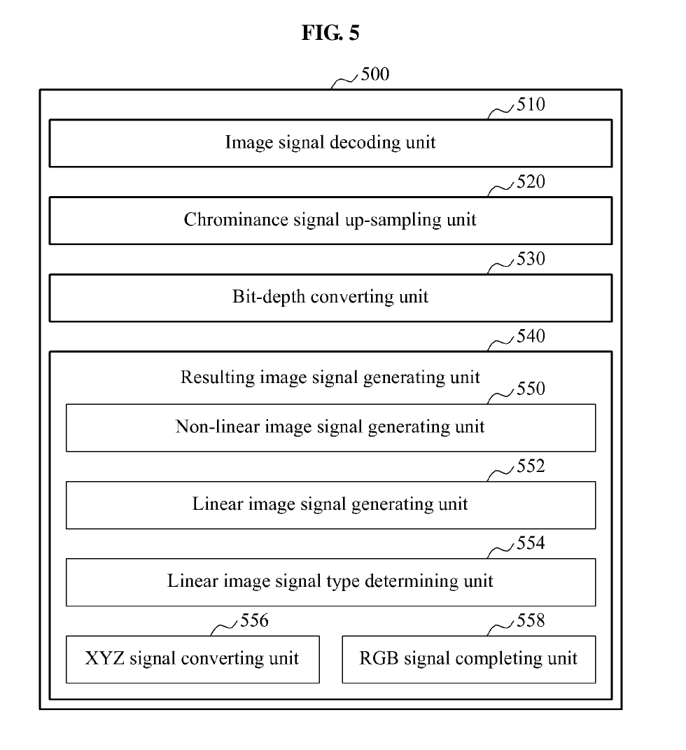

FIG. 5 illustrates an apparatus 500 for processing an image signal according to example embodiments.

The apparatus 500 may include an image signal decoding unit 510, a chrominance signal up-sampling unit 520, a bit-depth converting unit 530, and a resulting image signal generating unit 540.

The resulting image signal generating unit 540 may include a non-linear image signal generating unit 550, a linear image signal generating unit 552, a linear image signal type determining unit 554, an XYZ signal converting unit 556, and an RGB signal completing unit 558.

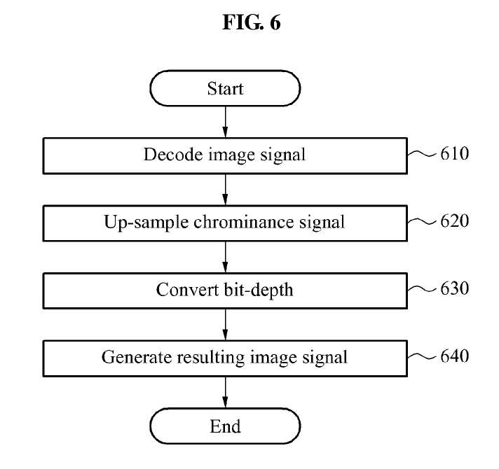

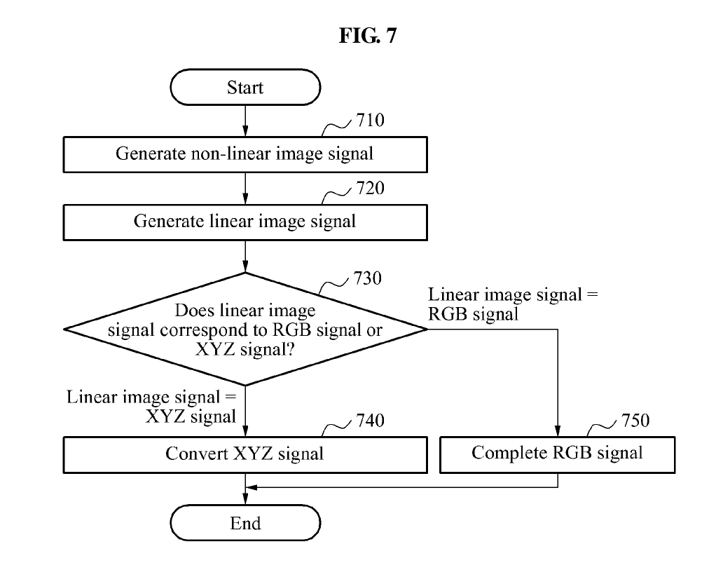

The aforementioned elements 510, 520, 530, 540, 550, 552, 554, 556, and 558 will be described in detail with reference to FIGS. 6 and 7.

The apparatus 100 of FIG. 1 for processing an image signal may be regarded as an image signal encoding apparatus, whereas the apparatus 500 of FIG. 5 for processing an image signal may be regarded as an image signal decoding apparatus.

FIG. 6 illustrates a method of processing an image signal according to example embodiments.

In operation 610, the image signal decoding unit 510 may generate a decoded image signal by decoding an encoded image signal.

The decoding may correspond to the encoding performed in operation 260.

The encoded image signal may correspond to the encoded independent luminance and chrominance image signal described with reference to FIG. 2. The decoded image signal may correspond to the independent luminance and chrominance image signal described with reference to FIG. 2. According to the descriptions provided with reference to FIG. 5, an input image signal may be encoded. Accordingly, the encoded image signal may correspond to an encoded input image signal, and the decoded image signal may correspond to the input image signal.

The decoded image signal may include a luminance signal and a chrominance signal.

In operation 620, the chrominance signal up-sampling unit 520 may up-sample values in a chrominance signal corresponding to a plurality of pixels represented by the decoded image signal, to become values corresponding to each of the plurality of pixels. For example, the values corresponding to each of the plurality of pixels may be identical to a value corresponding to the plurality of pixels. The values corresponding to each of the plurality of pixels may correspond to a value obtained by interpolating 1) values of neighboring pixels of each pixel, and 2) the value corresponding to the plurality of pixels.

In the up-sampling process, a resolution of the chrominance signal, which is lost as a result of the down-sampling performed in operation 250 of FIG. 2, may be restored.

In operation 630, the bit-depth converting unit 530 may convert a bit-depth of at least one of the luminance signal and the chrominance signal of the decoded image signal to a previously existing bit-depth before being converted by the bit-depth converting unit 160.

For example, when a bit-depth with respect to the chrominance signal of the independent luminance and chrominance image signal is reduced from n bits to m bits by the bit-depth converting unit 160 of FIG. 1, the bit-depth converting unit 530 may increase a bit-depth of the chrominance signal of the decoded image signal from m bits to n bits. Here, n may correspond to a natural number greater than m.

Operations 620 and 630 may be omitted, or may be performed in reverse order.

In operation 640, the resulting image signal generating unit 640 may generate a resulting image signal by restoring the decoded image signal to an RGB signal. A configuration and additional functions of the resulting image signal generating unit 640 will be described in detail with reference to FIG. 7.

The resulting image signal generating unit 540 may include a quantization restoring unit (not shown). The quantization restoring unit may perform an inverse conversion with respect to the quantization performed in operation 260 of FIG. 2. The quantization restoring unit may perform the inverse conversion with respect to each of a quantization of the luminance signal and a quantization of the chrominance signal.

FIG. 7 illustrates a method of generating an image signal according to example embodiments.

Operation 640 may include operations 710 through 750.

The decoded image signal of FIG. 6 may correspond to a restored luminance and chrominance image signal. The resulting image signal generating unit 540 may generate a resulting image signal, by converting the restored luminance and chrominance image signal to an RGB signal, through operations 710 through 750.

The method of generating an image signal in operations 710 through 750 may correspond to the method of generating the luminance and chrominance image signal described with reference to FIG. 3.

In operation 710, the non-linear image signal generating unit 550 may convert the restored luminance and chrominance image signal to a non-linear R′G′B′ signal or a non-linear X′Y′Z′ signal. The restored luminance and chrominance image signal may include a non-linear luminance signal, that is, a signal Y′, and non-linear chrominance signals, that is, a signal C′_{yb} and a signal C′_{rg}.

As expressed by Equation 9, the non-linear image signal generating unit 550 may generate a signal B′ and a signal R′ based on the signal Y′, the signal C′_{yb}, and the signal C′_{rg}. The non-linear image signal generating unit 550 may generate the signal B′ by applying an upper function of Equation 9 to the signal Y′ and the signal C′_{yb}. The non-linear image signal generating unit 550 may generate the signal R′ by applying a lower function of Equation 9 to the signal Y′ and the signal C′_{rg}.

$${B}^{′} = \{ \begin{matrix}1.9272 \cdot {C}_{yb}^{′} + {Y}^{′} , & - 0.5 \leq {C}_{yb}^{′} \leq 0 \\ 1.5244 \cdot {C}_{yb}^{′} + {Y}^{′} , & 0 < {C}_{yb}^{′} \leq 0.5\end{matrix} \\ {R}^{′} = \{ \begin{matrix}1.7758 \cdot {C}_{rg}^{′} + {Y}^{′} , & - 0.5 \leq {C}_{rg}^{′} \leq 0 \\ 1.1030 \cdot {C}_{rg}^{′} + {Y}^{′} , & 0 < {C}_{rg}^{′} \leq 0.5\end{matrix} \qquad [ Equation 9 ]$$

As expressed by Equation 10, the non-linear image signal generating unit 550 may generate a signal B′ and a signal G′ based on the signal Y′, the signal C′_{yb}, and the signal C′_{rg}. The non-linear image signal generating unit 550 may generate the signal B′ by applying an upper function of Equation 10 to the signal Y′ and the signal C′_{yb}. The non-linear image signal generating unit 550 may generate the signal G′ by applying a lower function of Equation 10 to the signal Y′ and the signal C′_{rg}.

$${B}^{′} = \{ \begin{matrix}1.9272 \cdot {C}_{yb}^{′} + {Y}^{′} , & - 0.5 \leq {C}_{yb}^{′} \leq 0 \\ 1.5244 \cdot {C}_{yb}^{′} + {Y}^{′} , & 0 < {C}_{yb}^{′} \leq 0.5\end{matrix} \\ {G}^{′} = \{ \begin{matrix}1.0510 \cdot {C}_{rg}^{′} + {Y}^{′} , & - 0.5 \leq {C}_{rg}^{′} \leq 0 \\ 0.3078 \cdot {C}_{rg}^{′} + {Y}^{′} , & 0 < {C}_{rg}^{′} \leq 0.5\end{matrix} \qquad [ Equation 10 ]$$

As expressed by Equation 11, the non-linear image signal generating unit 550 may generate a signal X′ and a signal Z′ based on the signal Y′, the signal C′_{yb}, and the signal C′_{rg}. The non-linear image signal generating unit 550 may generate a signal yb′ by applying an upper function of Equation 11 to the signal C′_{yb}. The non-linear image signal generating unit 550 may generate a signal rg′ by applying a lower function of Equation 11 to the signal C′_{rg}. The non-linear image signal generating unit 550 may generate the signal X′ and the signal Z′ by applying the functions and a matrix of Equation 11 to the signal Y′, the signal yb′, and the signal rg′.

$${yb}^{′} = \{ \begin{matrix}0.7756 \cdot {C}_{yb}^{′} , & - 0.5 \leq {C}_{yb}^{′} \leq 0 \\ 0.7866 \cdot {C}_{yb}^{′} , & 0 < {C}_{yb}^{′} < 0.5\end{matrix} \\ {rg}^{′} = \{ \begin{matrix}0.3070 \cdot {C}_{rg}^{′} + {Y}^{′} , & - 0.5 \leq {C}_{rg}^{′} \leq 0 \\ 0.3418 \cdot {C}_{rg}^{′} + {Y}^{′} , & 0 < {C}_{rg}^{′} < 0.5\end{matrix} \\ [ \begin{matrix}{X}^{′} \\ {Z}^{′}\end{matrix} ] = [ \begin{matrix}0.0010 & 1.5446 \\ 1.5389 & 0.7723\end{matrix} ] \cdot [ \begin{matrix}{yb}^{′} + 0.325 \cdot {Y}^{′} \\ {rg}^{′} + 0.6472 \cdot {Y}^{′}\end{matrix} ] \qquad [ Equation 11 ]$$

In operation 720, the linear image signal generating unit 552 may convert the non-linear R′G′B′ signal or the non-linear X′Y′Z′ signal to a linear RGB signal or a linear XYZ signal, by applying a linearization function of Equation 12 to the non-linear R′G′B′ signal or the non-linear X′Y′Z′ signal.

$$S \{ \begin{matrix}{S}^{′} / 4.5 , & 0 \leq S \leq 0.0814 \\ {[ ( {S}^{′} + 0.0993 ) / 1.0993 ]}^{( 1 / 0.45 )} , & 0.0814 〈 S \leq 1\end{matrix} \qquad [ Equation 12 ]$$

In Equation 12 above, S′ denotes the non-linear R′G′B′ signal or the non-linear X′Y′Z′ signal and S denotes the linear RGB signal or the linear XYZ signal.

The linear image signal generating unit 552 may convert and output a non-linear Y′ signal, a non-linear R′B′ signal, a non-linear G′B′ signal, and a non-linear X′Z′ signal to a linear luminance signal including a linear Y signal, a linear RB signal, a linear GB signal, and a linear XZ signal, respectively, by applying the linearization function of Equation 12 to the non-linear Y′ signal, the non-linear R′B′ signal, the non-linear G′B′ signal, and the non-linear X′Z′ signal. That is, the linear RGB signal generated and output by the linear image signal generating unit 552 may include the linear Y signal, the linear RB signal, and the linear GB signal.

In operation 730, the linear image signal type determining unit 554 may determine whether the linear image signal output from the linear image signal generating unit 552 corresponds to the linear RGB signal or the linear XYZ signal. When the linear image signal corresponds to the linear XYZ signal, operation 740 may be performed. When the linear image signal corresponds to the linear RGB signal, operation 750 may be performed.

In operation 740, the XYZ signal converting unit 556 may convert the linear XYZ signal to an RGB signal, by applying a matrix of Equation 13 to the linear XYZ signal.

$$[ \begin{matrix}R \\ G \\ B\end{matrix} ] [ \begin{matrix}3.2406 & - 1.5372 & - 0.4986 \\ - 0.9689 & 1.8758 & 0.0415 \\ 0.0557 & - 0.2040 & 1.0570\end{matrix} ] [ \begin{matrix}X \\ Y \\ Z\end{matrix} ] \qquad [ Equation 13 ]$$

In operation 750, the RGB signal completing unit 558 may obtain a full set of the linear RGB signal, by calculating a linear G signal or a linear R signal based on the signal Y, the linear RB signal, and the linear GB signal of the linear RGB signal, as expressed by Equation 14.

G=1.3982·Y−0.2973·R−0.1010·B

R=4.7037·Y−3.3641·G−0.3396·B [Equation 14]

The resulting image signal generating unit 540 may generate a resulting image using the generated linear RGB signal.

The apparatus 100 and the apparatus 500 may be used as parts of an image processing apparatus according to H.264/AVC standards, for example. For example, the apparatus 100 may be used as a luminance and chrominance quantization determining unit between a converting unit and a quantization unit. Also, the apparatus 500 may be used as a luminance and chrominance quantization restoring unit between a quantization unit and an inverse quantization unit. The apparatus 500 may be used as a luminance and chrominance quantization restoring unit between an entropy decoding unit and the inverse quantization unit.

The methods according to the above-described embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An apparatus for processing an image signal, the apparatus comprising:
an independent luminance and chrominance signal generating unit to convert a linear red, green, and blue (RGB) signal to an independent luminance and chrominance image signal comprising a luminance signal and a chrominance signal; and
an image signal encoding unit to encode the independent luminance and chrominance image signal,
wherein a non-linearization is performed on each of the luminance signal and the chrominance signal, and the non-linearization reduces a crosstalk property of the independent luminance and chrominance image signal.

2. The apparatus of claim 1, wherein the chrominance signal of the independent luminance and chrominance image signal has a value of 0 with respect to an achromatic color.

3. The apparatus of claim 1, further comprising:
a bit-depth converting unit to select at least one of the luminance signal and the chrominance signal of the independent luminance and chrominance image signal, and to convert a bit-depth of the at least one signal selected.

4. The apparatus of claim 1, further comprising:
a chrominance signal down-sampling unit to perform down-sampling on the chrominance signal of the independent luminance and chrominance image signal.

5. The apparatus of claim 1, wherein the image signal encoding unit comprises:
a quantization determining unit to determine different quantization parameter indices with respect to the luminance signal and the chrominance signal of the independent luminance and chrominance image signal, respectively.

6. The apparatus of claim 1, further comprising:
a luminance and chrominance image signal converting unit to convert an input image signal comprising a luminance signal and a chrominance signal to the linear RGB signal.

7. The apparatus of claim 6, wherein
the luminance and chrominance image signal converting unit comprises:
a hue information detecting unit to detect a red chromatic component, a magenta chromatic component, and a purple chromatic component from the chrominance signal of the input image signal; and
a hue information comparing unit to compare whether each of the detected red chromatic component, the detected magenta chromatic component, and the detected purple chromatic component has a value greater than a threshold value, and
the luminance and chrominance image signal converting unit determines whether to generate the independent luminance and chrominance image signal depending on a result of the comparison.

8. The apparatus of claim 1, wherein
the independent luminance and chrominance image signal generating unit comprises:
a linear luminance signal generating unit to generate a linear luminance signal based on the linear RGB signal;
a non-linear luminance signal generating unit to convert the linear luminance signal to a non-linear luminance signal;
an RGB signal converting unit to convert the linear RGB signal to a non-linear R′G′B′ signal; and
a chrominance signal generating unit to generate the chrominance signal of the independent luminance and chrominance image signal, using the non-linear luminance signal and the non-linear R′G′B′ signal, and
the non-linear luminance signal corresponds to the luminance signal of the independent luminance and chrominance image signal.

9. A method of processing an image signal, the method comprising:
converting a linear red, green, and blue (RGB) signal to an independent luminance and chrominance image signal comprising a luminance signal and a chrominance signal; and
encoding the independent luminance and chrominance image signal,
wherein a non-linearization is performed on each of the luminance signal and the chrominance signal, and the non-linearization reduces a crosstalk property of the independent luminance and chrominance image signal.

10. A non-transitory computer-readable recording medium storing a program to implement the method of claim 9.

11. An apparatus for processing an image signal, the apparatus comprising:
an image signal decoding unit to generate a decoded image signal by decoding an encoded image signal; and
a resulting image signal generating unit to generate a resulting image signal by restoring the decoded image signal to a red, green, and blue (RGB) signal,
wherein the decoded image signal corresponds to a luminance and chrominance image signal, and
the resulting image signal generating unit comprises:
a non-linear image signal generating unit to convert the luminance and chrominance image signal to a non-linear R′G′B′ signal;
a linear image signal generating unit to convert the non-linear R′G′B′ signal to a linear RGB signal comprising a linear luminance signal, a linear RB signal, and a linear GB signal; and
an RGB signal completing unit to obtain a full set of the RGB signal, by calculating a linear G signal or a linear R signal of the linear RGB signal based on the linear luminance signal, the linear RB signal, and the linear GB signal of the linear RGB signal.

12. The apparatus of claim 11, wherein
the non-linear image signal generating unit converts the luminance and chrominance image signal to a non-linear X′Y′Z′ signal,
the linear image signal generating unit converts the non-linear X′Y′Z′ signal to a linear XYZ signal, and
the resulting image signal generating unit further comprises:
an XYZ signal converting unit to convert the linear XYZ signal to the linear RGB signal.

13. The apparatus of claim 11, wherein the resulting image signal generating unit generates a resulting image using the RGB signal.

14. The apparatus of claim 11, further comprising:
a chrominance signal up-sampling unit to up-sample values in a chrominance signal corresponding to a plurality of pixels represented by the decoded image signal, to values corresponding to the plurality of pixels, respectively,
wherein the decoded image signal comprises the chrominance signal.

15. The apparatus of claim 11, further comprising:
a bit-depth converting unit to convert bit-depths of at least one of a luminance signal and a chrominance signal of the decoded image signal,
wherein the decoded image signal comprises the luminance signal and the chrominance signal.

16. A method of processing an image signal, the method comprising:
generating a decoded image signal by decoding an encoded image signal; and
generating a resulting image signal by restoring the decoded image signal to a red, green, and blue (RGB) signal,
wherein the decoded image signal corresponds to a luminance and chrominance image signal, and
the generating of the resulting image signal comprises:
converting the luminance and chrominance image signal to a non-linear R′G′B′ signal;
converting the non-linear R′G′B′ signal to a linear RGB signal comprising a linear luminance signal, a linear RB signal, and a linear GB signal; and
obtaining a full set of the RGB signal, by calculating a linear G signal or a linear R signal of the linear RGB signal based on the linear luminance signal, the linear RB signal, and the linear GB signal of the linear RGB signal.

17. A non-transitory computer-readable recording medium storing a program to implement the method of claim 16.

18. A system to reduce crosstalk in an image signal, the system comprising:
converting a linear red, green, and blue (RGB) signal to an independent luminance and chrominance image signal comprising a luminance signal and a chrominance signal by performing a non-linearization on each of the luminance signal and the chrominance signal;
encoding the independent luminance and chrominance image signal;
transmitting the encoded image signal;
receiving the encoded image signal;
generating a decoded image signal by decoding the encoded image signal; and
generating a resulting image signal by restoring the decoded image signal to a red, green, and blue (RGB) signal,
wherein the decoded image signal corresponds to a luminance and chrominance image signal, and
the generating of the resulting image signal comprises:
converting the luminance and chrominance image signal to a non-linear R′G′B′ signal;
converting the non-linear R′G′B′ signal to a linear RGB signal comprising a linear luminance signal, a linear RB signal, and a linear GB signal; and
obtaining a full set of the RGB signal, by calculating a linear G signal or a linear R signal of the linear RGB signal based on the linear luminance signal, the linear RB signal, and the linear GB signal of the linear RGB signal.
